(19) United States
(12) Patent Application Publication
(10) Pub. No.: US 2007/0035594 A1
(43) Pub. Date: Feb. 15, 2007

(54) Ink supply system

(76) Inventors: Jeffrey B. Brooks, Sullivan, NH (US); Jason Dean, Peterborough, NH (US); Edward E. Freyenhagen JR., Westmoreland, NH (US); Richard J. Larson JR., Walpole, NH (US); Scott G. Page, Alstead, NH (US)

Correspondence Address: FISH & RICHARDSON PC, P.O. BOX 1022, MINNEAPOLIS, MN, 55440-1022, US

(21) Appl. No.: 11/501,345

(22) Filed: Aug. 9, 2006

Related U.S. Application Data
(60) Provisional application No. 60/706,963, filed on Aug. 10, 2005.

(51) Int. Cl. B41J 2/175

(52) U.S. Cl. 347/85; 347/102

(57) ABSTRACT

An ink delivery system for a radiation-curable ink including a first reservoir to store a volume of ink, a second reservoir to receive at least a portion of the volume of ink from the first reservoir, a conveyor to transfer ink between the first reservoir and the second reservoir and an umbilical segment to provide fluid communication between at least one of the first and secondary reservoirs and a printing module.

### CROSS-REFERENCE TO RELATED APPLICATION

This application claims priority from U.S. Provisional Patent Application Ser. No. 60/706,963, filed on Aug. 10, 2005, which is incorporated herein by reference in its entirety.

### TECHNICAL FIELD

This invention relates to printing devices, and to related devices and methods.

### BACKGROUND

Some radiation-curable, e.g., UV-curable, jetting inks are liquid at room temperature. To ensure correct jetting viscosity, these liquid radiation-curable inks are often jetted above room temperature, e.g., 30° C. or more, e.g., 40° C. Such inks can be jetted onto substantially non-porous substrates, e.g., plastic pen barrels or circuit boards, or porous substrates. When such liquid radiation-curable inks are jetted onto a substrate, e.g., paper or plastic, to form an image, phenomena such as bleed-through, pinhole wetting and fisheyes due to the wetting characteristics of the liquid can result in inadequate ink coverage and overall poor print quality. One solution that is often used to reduce wicking is to treat the substrate to make it less porous. However, some inks do not perform well with such treatments. Another solution to minimizing wicking and bleed-through is to rapidly surface cure the ink, but often this does not completely eliminate wicking and bleed-through, and can require cumbersome and expensive equipment.

“Hybrid-F” radiation-curable jetting inks, i.e., those that polymerize by radical and/or cationic mechanisms to give polymer networks, are often described as “semi-solid inks,” and are more viscous at room temperature than at jetting temperature. Hybrid-F inks are available from Aellora™, e.g., under the tradename VistaSpec™ HB. Typically, these inks are jetted at elevated temperatures, e.g., above 60° C. or above 65° C., to lower ink viscosity to an appropriate jetting viscosity. After jetting hybrid-F ink, e.g., through a piezoelectric drop-on-demand inkjet printhead, ink viscosity rapidly increases as the ink cools on contact with the substrate. Once cooled to about room temperature, the hybrid-F ink does not flow without shear, allowing “wet-on-wet” printing without intermediate curing stages. Since the hybrid-F ink does not substantially flow at room temperature, wetting defects can be reduced, often reducing or eliminating the need for substrate surface treatments.

Liquid and hybrid-F radiation-curable inks typically contain inhibitors, e.g., hydroquinone (HQ) or hydroquinone monomethyl ether (MEHQ), which help to stabilize the ink, e.g. inhibit premature polymerization of the ink. Premature polymerization is problematic since it can clog small and delicate ink flow pathways and/or jetting nozzles within a print engine. While many inhibitors require the presence of oxygen to be effective, anaerobic inhibitors are also available that do not require the presence of oxygen to be effective.

### SUMMARY

This invention relates to printing devices, and to related devices and methods.

Generally, devices and methods are described that utilize ink handling systems in which ink in the systems have a reduced tendency to thermally polymerize, e.g., reducing a tendency of nozzle clogging.

In one aspect, an ink supply system for an ink containing a radiation-curable material includes a first reservoir to store a volume of ink, a second reservoir to receive at least a portion of the volume of ink from the first reservoir, a conveyor to transfer ink between the first reservoir and the second reservoir, a heater disposed between the first and second reservoirs, and an umbilical segment to provide fluid communication between at least one of the first and secondary reservoirs and a printing module.

In some embodiments, the ink is conveyed from the first reservoir to the second reservoir with vacuum pressure and/or the ink is conveyed from at least one of the first and second reservoirs to a print head with vacuum pressure. For example, the vacuum can be between about 8 psi and 12 psi.

The ink can, e.g., further include wax and/or a resin and or a polymerization inhibitor, such as hydroquinone.

The radiation-curable material can, e.g., include a cross-linkable material, such as a cross-linkable monomer and/or an oligomer. For example, the cross-linkable monomer can be a diacrylate or a diarylate, or mixtures of these. In some embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

In some embodiments, the first reservoir further includes a first reservoir heater and/or the second reservoir further includes a second reservoir heater.

In some embodiments, the ink passing along the umbilical segment is heated by electric resistance elements, such as an elongated or coiled wire longitudinally extending along the umbilical segment.

At least one of the first and second reservoirs can, e.g., include a pressure port to deliver air to the ink. For example, the pressure of the delivered air can be between about 10 psi and 15 psi.

In some implementations, the second reservoir further includes at least one angled surface to concentrate sediment from the ink.

If desired, the umbilical segment can be permeable to air.

In some instances, the printing module includes a third reservoir for receiving a portion of ink from at least one of the first and second reservoirs. In such instances, the third reservoir can include, if desired, a heating element.

In another aspect, a system for printing on a substrate includes a printing module configured to print an ink comprising a radiation-curable material, an ink delivery module which includes a first reservoir, a second reservoir and a transfer conduit extending between the first and second reservoirs, a conveyor to transfer the ink between the first and second reservoirs, and an umbilical segment to convey the ink from at least one of the first and second reservoirs to the printing module.

In some embodiments, the ink is conveyed from the first reservoir to the second reservoir with vacuum pressure and/or the ink is conveyed from at least one of the first and second reservoirs to a print head with vacuum pressure. For example, the vacuum can be between about 8 psi and 12 psi.

The ink can, e.g., further include wax and/or a resin and or a polymerization inhibitor, such as hydroquinone.

The radiation-curable material can, e.g., include a cross-linkable material, such as a cross-linkable monomer and/or an oligomer. For example, the cross-linkable monomer can be a diacrylate or a diarylate, or mixtures of these. In some embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

In some embodiments, the first reservoir further includes a first reservoir heater and/or the second reservoir further includes a second reservoir heater.

In some embodiments, the ink passing along the umbilical segment is heated by electric resistance elements, such as an elongated or coiled wire longitudinally extending along the umbilical segment.

At least one of the first and second reservoirs can, e.g., include a pressure port to deliver air to the ink. For example, the pressure of the delivered air can be between about 10 psi and 15 psi.

In some implementations, the second reservoir further includes at least one angled surface to concentrate sediment from the ink.

If desired, the umbilical segment can be permeable to air.

In some instances, the printing module includes a third reservoir for receiving a portion of ink from at least one of the first and second reservoirs. In such instances, the third reservoir can include, if desired, a heating element.

In another aspect, a method of delivering ink to a substrate includes conveying the ink which contains a radiation-curable material along an ink pathway from a first reservoir to a second reservoir. The ink pathway includes a transfer heater configured to raise the ink to a first predetermined temperature such that the ink remains in a substantially single phase. The ink is heated to a second predetermined temperature along an umbilical segment connecting at least one of the first and second reservoirs to a print head and delivered from the ink from the print head to the substrate.

In some embodiments, the ink is conveyed from the first reservoir to the second reservoir with vacuum pressure and/or the ink is conveyed from at least one of the first and second reservoirs to a print head with vacuum pressure. For example, the vacuum can be between about 8 psi and 12 psi.

The ink can, e.g., further include wax and/or a resin and or a polymerization inhibitor, such as hydroquinone.

The radiation-curable material can, e.g., include a cross-linkable material, such as a cross-linkable monomer and/or an oligomer. For example, the cross-linkable monomer can be a diacrylate or a diarylate, or mixtures of these. In some embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

In some embodiments, the first reservoir further includes a first reservoir heater and/or the second reservoir further includes a second reservoir heater.

In some embodiments, the ink passing along the umbilical segment is heated by electric resistance elements, such as an elongated or coiled wire longitudinally extending along the umbilical segment.

At least one of the first and second reservoirs can, e.g., include a pressure port to deliver air to the ink. For example, the pressure of the delivered air can be between about 10 psi and 15 psi.

In some implementations, the second reservoir further includes at least one angled surface to concentrate sediment from the ink.

If desired, the umbilical segment can be permeable to air.

In some instances, the printing module includes a third reservoir for receiving a portion of ink from at least one of the first and second reservoirs. In such instances, the third reservoir can include, if desired, a heating element.

As an example, the first temperature can be about 65° C. and the second temperature can be about 68° C.

The heating can, e.g., be performed with ultrasound, a heat exchanger (e.g., a thin-walled heat exchanger), microwave energy, or a PTC thermistor. When microwaves are utilized, a microwave-absorbing material can be added to the ink.

In another aspect, a method of delivering an ink to a substrate includes circulating an ink which contains a radiation-curable material from a first reservoir and a second reservoir and through a transfer heater to raise the ink to a predetermined first temperature, conveying the ink from at least one of the first and second reservoirs to a print head along an umbilical segment, heating the ink along the umbilical segment to a second predetermined temperature, and delivering the ink to the substrate.

In some embodiments, the ink is conveyed from the first reservoir to the second reservoir with vacuum pressure and/or the ink is conveyed from at least one of the first and second reservoirs to a print head with vacuum pressure. For example, the vacuum can be between about 8 psi and 12 psi.

The ink can, e.g., further include wax and/or a resin and or a polymerization inhibitor, such as hydroquinone.

The radiation-curable material can, e.g., include a cross-linkable material, such as a cross-linkable monomer and/or an oligomer. For example, the cross-linkable monomer can be a diacrylate or a diarylate, or mixtures of these. In some embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

In some embodiments, the first reservoir further includes a first reservoir heater and/or the second reservoir further includes a second reservoir heater.

In some embodiments, the ink passing along the umbilical segment is heated by electric resistance elements, such as an elongated or coiled wire longitudinally extending along the umbilical segment.

At least one of the first and second reservoirs can, e.g., include a pressure port to deliver air to the ink. For example, the pressure of the delivered air can be between about 10 psi and 15 psi.

In some implementations, the second reservoir further includes at least one angled surface to concentrate sediment from the ink.

If desired, the umbilical segment can be permeable to air.

In some instances, the printing module includes a third reservoir for receiving a portion of ink from at least one of the first and second reservoirs. In such instances, the third reservoir can include, if desired, a heating element.

As an example, the first temperature can be about 65° C. and the second temperature can be about 68° C.

The heating can, e.g., be performed with ultrasound, a heat exchanger (e.g., a thin-walled heat exchanger), microwave energy, or a PTC thermistor. When microwaves are utilized, a microwave-absorbing material can be added to the ink.

Ultraviolet radiation, e.g., electromagnetic energy with a wavelength from about 200 nm to about 400 nm, and visible light, e.g., electromagnetic energy with a wavelength from about 400 nm to about 700 nm, or a combination thereof, are examples of radiation sources.

Embodiments may have one or more of the following advantages. Generally, the material, such as ink, in the material-handling systems has enhanced stability, e.g., a reduced tendency to polymerize and/or exhibit a stable viscosity. For example, the ink handling systems have a reduced tendency to thermally polymerize ink flowing through the ink flow pathways, which can result in a system having enhanced ink flow and jetting performance. Such ink handling systems have a reduced tendency for ink flow pathway blockage, nozzle clogging, and/or valve blockage. This in turn reduces cleaning downtime and improves printing efficiency. Keeping the often small and delicate flow paths and/or nozzles clear of environmental containments allows the ink to flow through the flow paths with reduced resistance. Lower resistance to flow enables, e.g., a more rapid refilling of the pumping chamber. For example, rapidly refilling the pumping chamber can translate into an ability to eject drops at a higher frequency, e.g., 10 kHz, 25 kHz, 50 kHz or higher, e.g., 75 kHz. Higher frequency printing can improve the resolution of ejected drops by increasing the rate of drop ejection, reducing size of the ejected drops, and enhancing velocity uniformity of the ejected drops. In addition, keeping nozzles and/or flow paths clear of polymerized ink can reduce ejection errors, such as mis-fires or trajectory errors, and thereby improve overall print quality.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference herein in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a schematic view of a printing apparatus, including an ink supply module.

FIG. 2 is a perspective schematic view of an ink supply module and a printing module.

FIG. 3 is a cross-sectional view of the ink supply module of FIG. 2.

FIGS. 4A and 4B are perspective front and back views of a print head, respectively.

FIG. 5 is a detailed perspective view of a portion of a print head.

FIG. 6 is a flow chart representation of one process of the printing apparatus of FIG. 1.

Like reference symbols in the various drawings indicate like elements.

### DETAILED DESCRIPTION

Generally, devices and methods are described that utilize ink handling systems in which ink in the systems has a reduced tendency to thermally polymerize during conveyance. Described systems can, e.g., reduce ink flow pathway blockages and nozzle clogging.

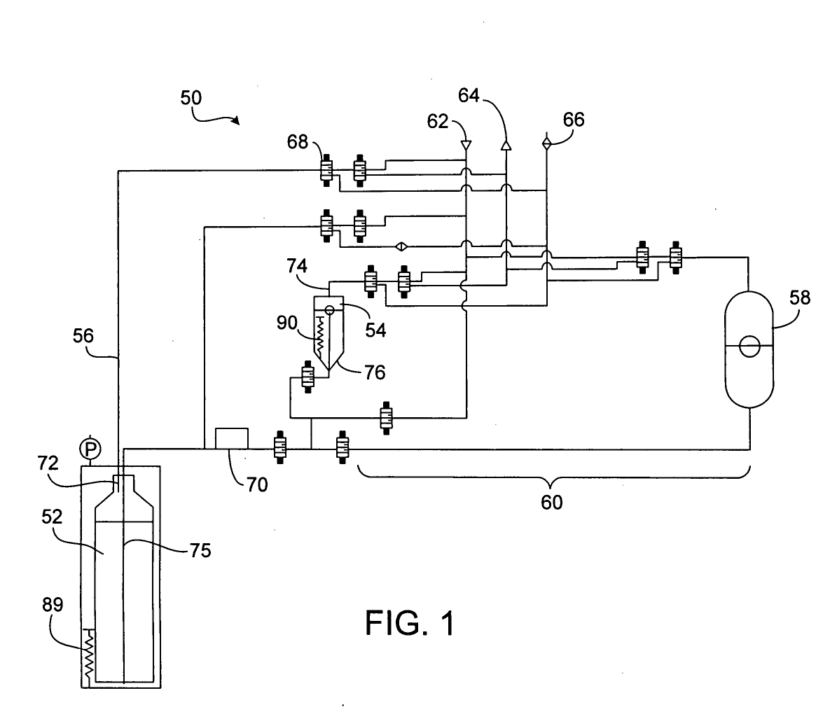

Referring to FIG. 1, an ink delivery system 50 includes a first reservoir 52 in fluid communication with a second reservoir 54 along an ink pathway 56. Ink is circulated between the primary reservoir 52 and the secondary reservoir 54 and to a printing module 58 for jetting along one or more umbilical segments 60. In some examples, the primary reservoir 52 is the ink supply container. The umbilical segment 60 can be formed from a flexible, air permeable membrane, such as Teflon®, for example, to oxygenate the ink. In particular implementations, the umbilical segment 60 can include disks (not shown) of a semi-permeable material, e.g., expanded fluoropolymer material, along its length. The semi-permeable nature of the disk prevents ink from escaping the umbilical segment 60, while allowing air to pass through to the ink. Oxygen works in combination with inhibitors in the ink to reduce thermal polymerization of the ink components. A substantially linear or coiled concentric resistance heating wire (not shown) can extend along the length of the umbilical segment 60 to transfer additional heat to the ink as it is conveyed to the print module 58. In one example, the ink is conveyed along the ink pathway 56 without the use of any internal pumps by introducing a pressure differential to the ink delivery system 50 at a pressure inlet 62, a vacuum inlet 64 and a vent inlet 66 directed with one or more valves 68. In one example, a vacuum of 10 psi, for example, is used to transport the ink. In various embodiments, a heated liquid (e.g., water, not shown) surrounds the umbilical segment 60 to raise the temperature of the ink delivered to the print module 58. Alternatively, electric resistance heating elements are applied around the umbilical segment 60 to heat the ink.

An ink transfer heater 70, such as an aluminum plate-and-frame heat exchanger for example, is located between the first and second reservoirs 52, 54 to raise the temperature of the ink. The heating of the ink can also be accomplished with, for example, RF energy, microwaves, ultrasound, PTC thermistors or resistive heating elements, as described in U.S. Provisional Application Ser. No. 60/706,865, filed Aug. 10, 2005. The ink can also be heated using frictional heating or by chemical means. The reservoirs 52, 54 can also include pressure ports 72, 74 for providing air to the ink contained within the reservoirs at a pressure of about 12 psi in one example. The pressure ports can oxygenate the ink and reduce settling of particulates, such as TiO₂, in one example. An intake conduit 75 can extend into the interior of the first reservoir to deliver ink to and from the reservoir. The second reservoir 54 can include a conical or inclined portion 76 to direct sediment in the ink, such as TiO₂ to a concentrated area for ease of removal.

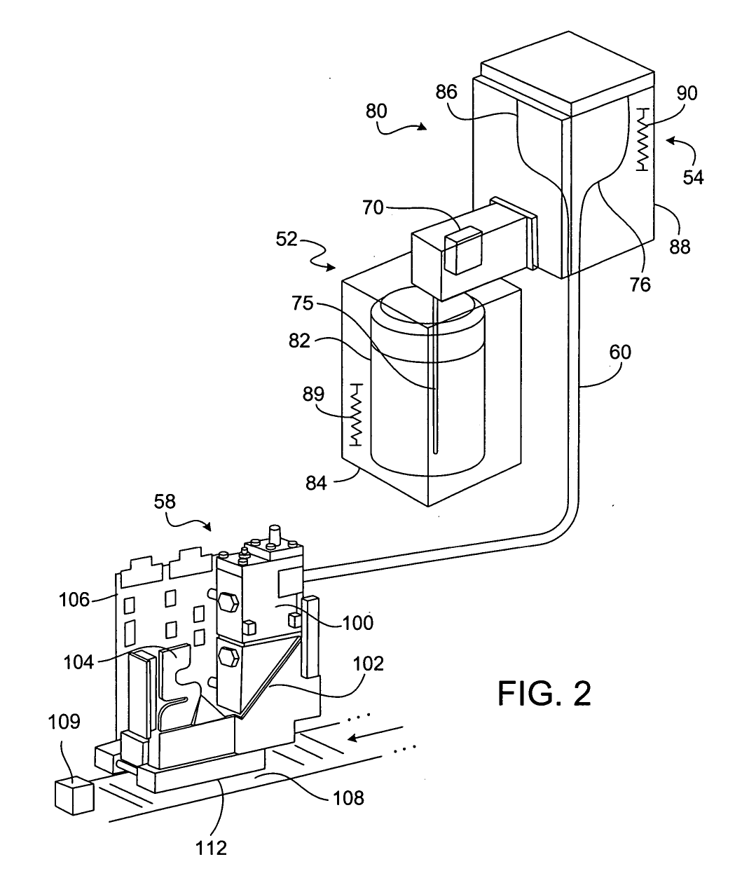

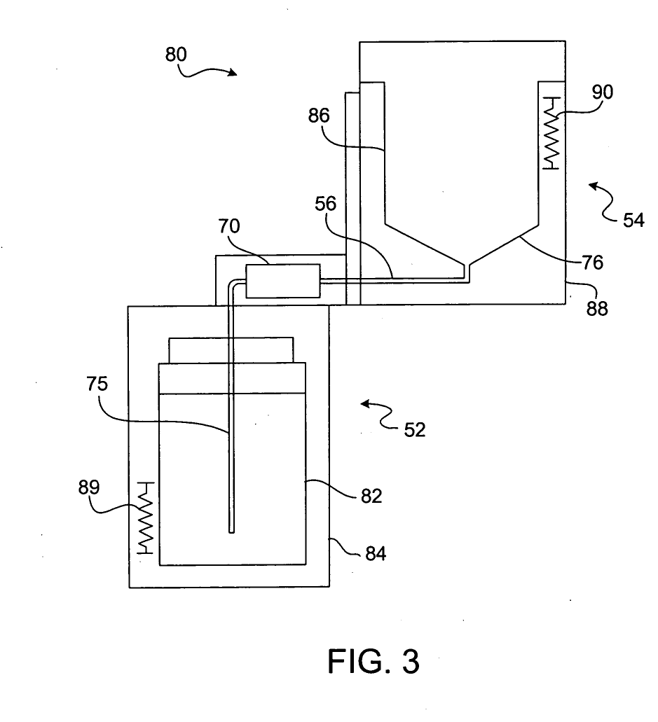

Referring now to FIGS. 2 and 3, in one example, the first and second reservoirs 52, 54, together form a reservoir assembly 80. The assembly 80 is substantially contained within a metal block and the first reservoir 52 includes a plastic supply container 82 connected to the ink pathway 56 with detachable seals (not shown) and disposed within a housing 84. In one example, the liner 82 is formed from plastic and the housing 84 is formed from aluminum. The second reservoir 54 can be formed from a construction including a liner 86 disposed within a housing 88. The first and second reservoirs can also include an integral cartridge heaters 89, 90, respectively, to supplement the heat introduced to the ink by the ink transfer heater 70. The ink is heated to temperature, Temp₁, which is about 65° C., in one example, while contained within the reservoir assembly 80. In one example, the volume of the first reservoir is about 1 liter and the volume of the second reservoir is between about 1 and 1.2 liters.

With specific reference to the embodiment of FIG. 2, the ink is conveyed through the umbilical segment 60 to a print module reservoir 100 in the printing module 58, where the temperature of the ink is maintained at Temp₂, a suitable jetting temperature. In some examples, the umbilical segment 60 can include one or more filters 101, e.g., screen-type filters or sintered-type filters. Such filters can remove dust, debris and gels from the ink which can block ink flow pathways, nozzles, valves and/or filters, leading to a reduction in print quality. Such filters can also be located at other suitable locations along the ink flow pathways.

In some instances, the heating of the ink within the reservoir assembly 80 increases ink temperature to a Temp₁ that is within about 15° C. of ink residing in the print module reservoir 100 to minimize the possibility that the ink in the reservoir 100 is thermally shocked by the ink entering from the reservoir assembly 80. The ink then travels along flow pathway 102 to print head 104. Controller 106 controls the jetting of ink onto a substrate 108, which is traveling below the print head.

Ink drop ejection is controlled by pressurizing ink with an actuator, which may be, for example, a piezoelectric actuator, a thermal bubble jet generator, or an electrostatically deflected element. Typically, print head 104 has an array of ink pathways with corresponding nozzle openings and associated actuators, such that drop ejection from each nozzle opening can be independently controlled. U.S. Pat. No. 5,265,315 describes a print head that has a semiconductor body and a piezoelectric actuator. Piezoelectric inkjet print heads are described in U.S. Pat. Nos. 4,825,227, 4,937,598, 5,659,346, 5,757,391, and in U.S. Patent Application No. 2004/0004649 (now issued as U.S. Pat. No. 7,052,117), all of which are incorporated herein by reference in their entirety. The ink on substrate 108, e.g., in the form of text or graphics, is cured with a radiation source 109, such as ultra-violet light or e-beam radiation, for example. If UV radiation is used to cure the radiation-curable material, a wavelength of the ultraviolet light that cures the radiation-curable material is between about 200 nm and about 400 nm, e.g., a typical output from a medium pressure, metal-doped lamp, e.g., an iron-mercury lamp.

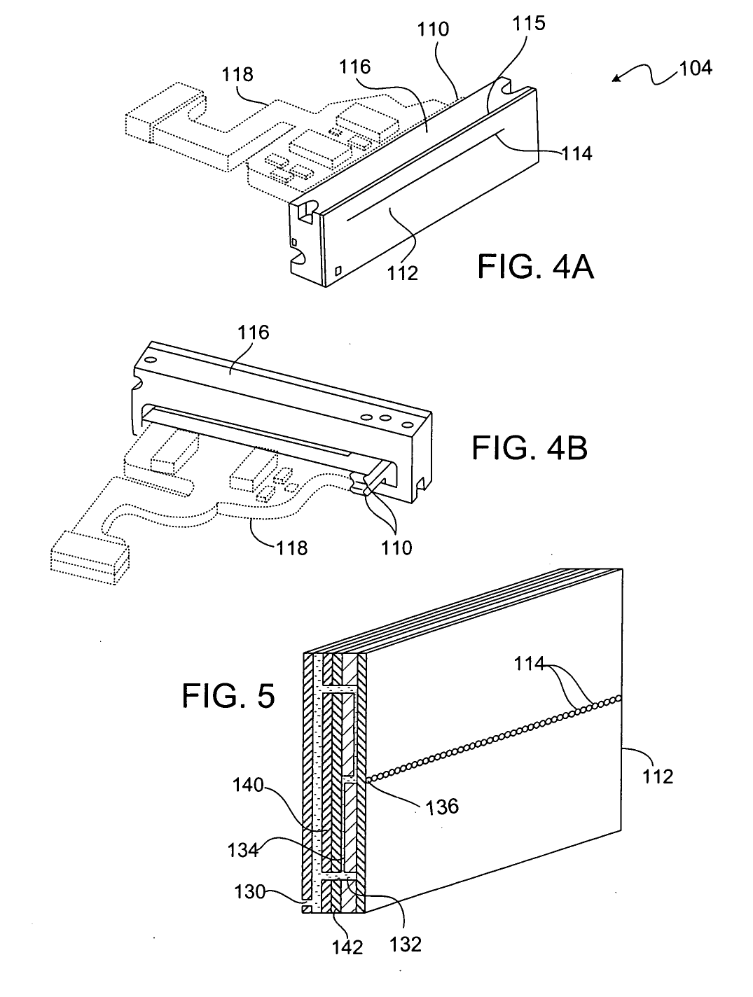

Referring now to FIGS. 4A, 4B and 5, a piezoelectric inkjet print head 104 includes jetting modules 110 and an orifice plate 112 with an array of orifice openings 114. The orifice plate 112 is mounted on a manifold 115 and attached to a collar 116. The inkjet print head 104 is controlled by electrical signals conveyed by flexprint elements 118 that are in electrical communication with controller 106 (FIG. 2) of print module 58.

Referring particularly to FIG. 5, in operation, ink flows from a reservoir (not shown) into a first passage 130. The ink is then conveyed through a second passage 132 to a pressure chamber 134, and then through an orifice passageway 136 and a corresponding orifice 114 in the orifice plate 112 in response to selective actuation of an adjacent portion 140 of a piezoelectric actuator plate 142. Exemplary commercial inkjet print heads are available from Spectra, Inc., Hanover, N.H. (now the Spectra Printing Division of Dimatix, Inc).

Generally, suitable inks include colorants, polymerizable materials, e.g., monomers and/or oligomers, and photoinitiating systems. The polymerizable materials can be cross-linkable.

Colorants include pigments, dyes, or combinations thereof. In some implementations, inks include less than about 10 percent by weight colorant, e.g., 7.5 percent, 5 percent, 2.5 percent or less, e.g., 0.1 percent.

The pigment can be black, cyan, magenta, yellow, red, blue, green, brown, or a mixture these colors. Examples of suitable pigments include carbon black, graphite and titanium dioxide. Additional examples are disclosed in, e.g., U.S. Pat. No. 5,389,133.

Alternatively or in addition to the pigment, the inks can contain a dye. Suitable dyes include, e.g., Orasol Pink 5BLG, Black RLI, Blue 2GLN, Red G, Yellow 2GLN, Blue GN, Blue BLN, Black CN, and Brown CR, each being available from Ciba-Geigy. Additional suitable dyes include Morfast Blue 100, Red 101, Red 104, Yellow 102, Black 101, and Black 108, each being available from Morton Chemical Company. Other examples include, e.g., those disclosed in U.S. Pat. No. 5,389,133.

Mixtures of colorants may be employed.

Generally, the inks contain a polymerizable material, e.g., one or more polymerizable monomers. The polymerizable monomers can be mono-functional, di-functional, tri-functional or higher functional, e.g., penta-functional. The mono-, di- and tri-functional monomers have, respectively, one, two, or three functional groups, e.g., unsaturated carbon-carbon groups, which are polymerizable by irradiating in the presence of photoinitiators. In some implementations, the inks include at least about 40 percent, e.g., 50 percent, 60 percent or more, e.g., 80 percent by weight polymerizable material. Mixtures of polymerizable materials can be utilized, e.g., a mixture containing mono-functional and tri-functional monomers. The polymerizable material can optionally include diluents.

Examples of mono-functional monomers include long chain aliphatic acrylates or methacrylates, e.g., lauryl acrylate or stearyl acrylate, and acrylates of alkoxylated alcohols, e.g., 2-(2-ethoxyethoxy)-ethyl acrylate.

The di-functional material can be, e.g., a diacrylate of a glycol or a polyglycol. Examples of the diacrylates include the diarylates of diethylene glycol, hexanediol, dipropylene glycol, tripropylene glycol, cyclohexane dimethanol (Sartomer CD406), and polyethylene glycols.

Examples of tri- or higher functional materials include tris(2-hydroxyethyl)-isocyanurate triacrylate (Sartomer SR386), dipentaerythritol pentaacrylate (Sartomer SR399), and alkoxylated acrylates, e.g., ethoxylated trimethylolpropane triacrylates (Sartomer SR454), propoxylated glyceryl triacrylate, and propoxylated pentaerythritol tetraacrylate.

The inks may also contain one or more oligomers or polymers, e.g., multi-functional oligomers or polymers.

In some instances, the viscosity of the ink is between about 1 centipoise and about 50 centipoise, e.g., from about 5 centipoise to about 45 centipoise, or from about 7 centipoise to about 35 centipoise, at a temperature ranging from about 20° C. to about 150° C.

A photoinitiating system, e.g., a blend, in the inks is capable of initiating polymerization reactions upon irradiation, e.g., ultraviolet light irradiation.

The photoinitiating system can include, e.g., an aromatic ketone photoinitiator, an amine synergist, an alpha-cleavage type photoinitiator, and/or a photosensitizer. Each component is fully soluble in the monomers and/or diluents described above. Specific examples of the aromatic ketones include, e.g., 4-phenylbenzophenone, dimethyl benzophenone, trimethyl benzophenone (Esacure TZT), and methyl O-benzoyl benzoate.

An amine synergist can be utilized. For example, the amine synergist can be a tertiary amine. Specific examples of the amine synergists include, e.g., 2-(dimethylamino)-ethyl benzoate, ethyl 4-(dimethylamino) benzoate, and amine functional acrylate synergists, e.g., Sartomer CN384, CN373.

An alpha-cleavage type photoinitiator can be an aliphatic or aromatic ketone. Examples of the alpha-cleavage type photoinitiators include, e.g., 2,2-dimethoxy-2-phenyl acetophenone, 2,4,6-trimethylbenzoyl-diphenylphosphine oxide, and 2-methyl-1-[4-(methylthio)phenyl-2-morpholino propan-1-one (Irgacure 907).

A photosensitizer can be a substance that either increases the rate of a photoinitiated polymerization reaction or shifts the wavelength at which the polymerization reaction occurs. Examples of photosensitizers include, e.g., isopropylthioxanthone (ITX), diethylthioxanthone and 2-chlorothioxanthone.

The inks may contain an adjuvant such as a vehicle (e.g., a wax or resin), a stabilizer, an oil, a flexibilizer, or a plasticizer. The stabilizer can, e.g., inhibit oxidation of the ink. The oil, flexibilizer, and plasticizer can reduce the viscosity of the ink.

Examples of waxes include, e.g., stearic acid, succinic acid, beeswax, candelilla wax, carnauba wax, alkylene oxide adducts of alkyl alcohols, phosphate esters of alkyl alcohols, alpha alkyl omega hydroxy poly (oxyethylene), allyl nonanoate, allyl octanoate, allyl sorbate, allyl tiglate, bran wax, paraffin wax, microcrystalline wax, synthetic paraffin wax, petroleum wax, cocoa butter, diacetyl tartaric acid esters of mono and diglycerides, alpha butyl omega hydroxypoly(oxyethylene)poly(oxypropylene), calcium pantothenate, fatty acids, organic esters of fatty acids, amides of fatty acids (e.g., stearamide, stearyl stearamide, erucyl stearamide (e.g., Kemamide S-221 from Crompton-Knowles/Witco), calcium salts of fatty acids, mono & diesters of fatty acids, lanolin, polyhydric alcohol diesters, oleic acids, palmitic acid, d-pantothenamide, polyethylene glycol (400) dioleate, polyethylene glycol (MW 200-9,500), polyethylene (MW 200-21,000); oxidized polyethylene; polyglycerol esters of fatty acids, polyglyceryl phthalate ester of coconut oil fatty acids, shellac wax, hydroxylated soybean oil fatty acids, stearyl alcohol, and tallow and its derivatives.

Examples of resins include, e.g., acacia (gum arabic), gum ghatti, guar gum, locust (carob) bean gum, karaya gum (sterculia gum), gum tragacanth, chicle, highly stabilized rosin ester, tall oil, manila copais, corn gluten, coumarone-indene resins, crown gum, damar gum, dimethylstyrene, ethylene oxide polymers, ethylene oxide/propylene oxide copolymer, heptyl paraben, cellulose resins, e.g., methyl and hydroxypropyl; hydroxypropyl methylcellulose resins, isobutylene-isoprene copolymer, polyacrylamide, functionalized or modified polyacrylamide resin, polyisobutylene, polymaleic acid, polyvinyl acetate, polyvinyl alcohol, polyvinyl pyrrolidone, rosin, pentaerythritol ester, purified shellac, styrene terpolymers, styrene copolymers, terpene resins, turpentine gum, zanthan gum and zein.

Examples of stabilizers, oils, flexibilizers and plasticizers include, e.g., methylether hydroquinone (MEHQ), hydroquinone (HQ), butylated hydroxyanisole (BHA), butylated hydoxytoluene (BHT), propyl gallate, tert-butyl hydroquinone (TBHQ), ethylenediaminetetraacetic acid (EDTA), methyl paraben, propyl paraben, benzoic acid, glycerin, lecithin and modified lecithins, agar-agar, dextrin, diacetyl, enzyme modified fats, glucono delta-lactone, carrot oil, pectins, propylene glycol, peanut oil, sorbitol, brominated vegetable oil, polyoxyethylene 60 sorbitan monostearate, olestra, castor oil; 1,3-butylene glycol, coconut oil and its derivatives, corn oil, substituted benzoates, substituted butyrates, substituted citrates, substituted formats, substituted hexanoates, substituted isovalerates, substituted lactates, substituted propionates, substituted isobutyrates, substituted octanoates, substituted palmitates, substituted myristates, substituted oleates, substituted stearates, distearates and tristearates, substituted gluconates, substituted undecanoates, substituted succinates, substituted gallates, substituted phenylacetates, substituted cinnamates, substituted 2-methylbutyrates, substituted tiglates, paraffinic petroleum hydrocarbons, glycerin, mono- and diglycerides and their derivatives, polysorbates 20, 60, 65, 80, propylene glycol mono- and diesters of fats and fatty acids, epoxidized soybean oil and hydrogenated soybean oil.

Additional inks have been described by Woudenberg in Published U.S. Patent Application No. 2004/0132862 (now issued as U.S. Pat. No. 6,896,937).

In some embodiments, the inks used are hybrid-F UV curable jetting inks and the print head used is the SureFire 65™ print head.

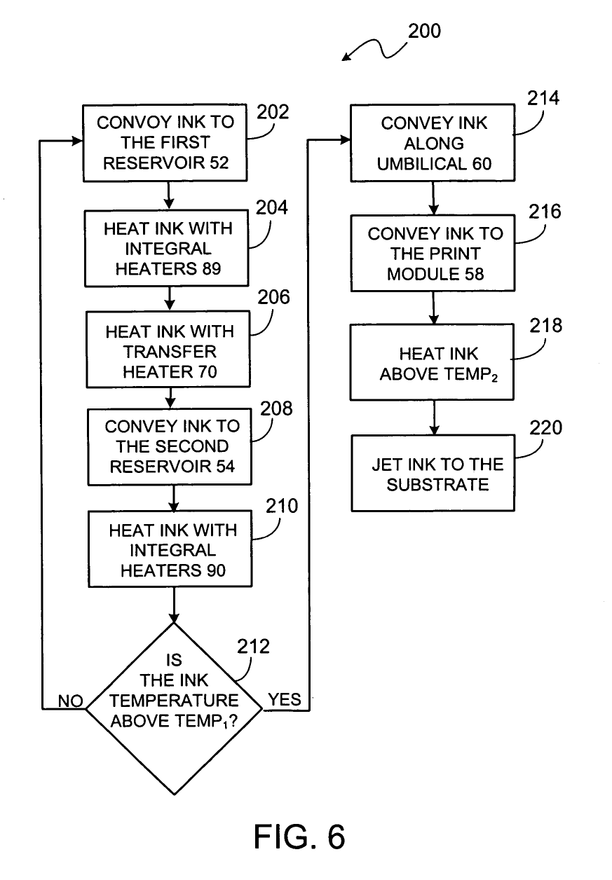

Referring to FIG. 6, one process 200 for the printing apparatus 50 conveys (202) a volume of ink to the first reservoir 52 and heats (204) the ink with the integral heater 89. Process 200 heats (206) the ink while it is directed through the ink transfer heater 70 and conveys (208) the ink to the second reservoir 54. While the ink is contained within the second reservoir, process 200 heats (210) the ink with integral heater 90. In one example, the ink is heated from about 25° C. to temperature Temp₁ during a time period of Time₁. The ink can be heated through the combined effect of the circulation through the ink transfer heater 70 (between the first and second reservoirs 52, 54) and the integral heaters 89, 90 of each of the reservoirs. In one example, Temp₁ is about 65° C. and Time₁ is about 15 minutes. In some implementations, the ink is substantially homogenous at 65° C. Process 200 measures (212) the ink temperature to determine whether it is greater than Temp₁. If the ink temperature is greater than about Temp₁, process 200 conveys (214) the ink along the umbilical segment 60 toward the print module 58. If the ink temperature is less than about Temp₁, the ink is recirculated from the second reservoir to the first reservoir and back through the ink transfer heater 70. While process 200 delivers (214) the ink along the umbilical segment 60, the ink can be heated with the elongated or coiled resistance-heating element extending therethrough, for example. Process conveys (216) ink to the print module 58 and heats (218) the ink while in the print module reservoir 100 to a suitable jetting temperature, Temp₂, where Temp₂ is generally higher than Temp₁. In one example, the jetting temperature Temp₂ is about 68° C. Process 200 then jets (220) the ink from the print head 104 onto a substrate.

### Other Embodiments

While certain embodiments have been described, other embodiments are possible. For example, while the embodiment of FIG. 1 utilizes a single color ink, in some embodiments, a devices and methods described utilize ink handling systems in which more than one color of ink is conveyed, e.g., two, three, four, five, six, seven or more, for multi-color printing to the substrate.

While inks have been discussed, the devices and methods disclosed are suitable for other jetting materials, e.g., clear overcoat materials, or flavors and/or fragrances.

Other embodiments are within the scope of the following claims.

What we claim is:

1. An ink supply system for an ink comprising a radiation-curable material, the system comprising:
a first reservoir to store a volume of ink;
a second reservoir to receive at least a portion of the volume of ink from the first reservoir;
a conveyor to transfer ink between the first reservoir and the second reservoir;
a heater disposed between the first and second reservoirs; and
an umbilical segment to provide fluid communication between at least one of the first and secondary reservoirs and a printing module.

2. The ink supply system of claim 1, wherein the ink is conveyed from the first reservoir to the second reservoir with vacuum pressure.

3. The ink supply system of claim 2, wherein the vacuum is between about 8 and 12 psi.

4. The ink supply system of claim 1, wherein the first reservoir further comprises a first reservoir heater.

5. The ink supply system of claim 1, wherein the second reservoir further comprises a second reservoir heater.

6. The ink supply system of claim 1, wherein the ink passing along the umbilical segment is heated by electric resistance elements.

7. The ink supply system of claim 1, wherein at least one of the first and second reservoir comprises a pressure port to delivery air to the ink.

8. The ink supply system of claim 7, wherein a pressure of the air is between about 10 psi and 15 psi.

9. The ink supply system of claim 1, wherein the radiation-curable material comprises a cross-linkable material.

10. The ink supply system of claim 1, the cross-linkable material comprises a diacrylate and/or a diarylate.

11. The ink supply system of claim 1, wherein the cross-linkable material comprises a monomer selected from the group consisting of (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, and mixtures thereof.

12. A system for printing on a substrate, the system comprising:
a printing module configured to print an ink comprising a radiation-curable material;
an ink delivery module comprising a first reservoir, a second reservoir and a transfer conduit extending therebetween;
a conveyor to transfer the ink between the first and second reservoirs; and
an umbilical segment to convey the ink from at least one of the first and second reservoirs to the printing module.

13. The system of claim 12, wherein the ink is conveyed from the first reservoir to the second reservoir with vacuum pressure.

14. The system of claim 13, wherein the vacuum is between about 8 psi and 12 psi.

15. The system of claim 12, wherein the first reservoir further comprises a first reservoir heater.

16. The system of claim 12, wherein the second reservoir further comprises a second reservoir heater.

17. The system of claim 12, wherein the ink passing along the umbilical segment is heated by electric resistance elements.

18. The system of claim 12, wherein at least one of the first and second reservoir comprises a pressure port to delivery air to the ink.

19. The system of claim 12, wherein the printing module comprises a third reservoir for receiving a portion of ink from at least one of the first and second reservoirs.

20. The system of claim 19, wherein the third reservoir comprises a heating element.
